(19) United States
(12) Patent Application Publication
(10) Pub. No.: US 2007/0136334 A1
(43) Pub. Date: Jun. 14, 2007

(54) Communication system and methods

(76) Inventors: David A. Schleppenbach, Lafayette, IN (US); Joe P. Said, West Lafayette, IN (US); Abraham Nemeth, Southfield, MI (US)

Correspondence Address: Keith J. Swedo;Sommer Barnard, One Indiana Square, Suite 3500, Indianapolis, IN, 46204, US

(21) Appl. No.: 10/579,377

(22) PCT Filed: Nov. 15, 2004
(86) PCT No.: PCT/US04/38141

§ 371 Date: May 12, 2006

Related U.S. Application Data
(60) Provisional application No. 60/519,748, filed on Nov. 13, 2003.
(60) Provisional application No. 60/519,754, filed on Nov. 13, 2003.

(51) Int. Cl. G06F 7/00

(52) U.S. Cl. 707/101

(57) ABSTRACT

An apparatus and methods for creating a precise, consistent communication of technical notations is disclosed (100). The apparatus and methods provide a standardization for the aural communication of mathematics and scientific content that clearly communicates equations, derivatives, integrals, fractions, and other algebraic, scientific, and mathematical components (12). This standard of communication (100) can be incorporated in software (12) that is capable of utilizing numerous types of input (10) and is capable of output (24) utilizing a number of methods and/or devices.

### RELATED APPLICATIONS

This application claims the priority of U.S. patent application Ser. No. 60/519,748, filed on Nov. 13, 2003, and U.S. patent application Ser. No.60/519,754, filed on Nov. 13, 2003, incorporated herein by reference.

### FIELD OF THE INVENTION

The present invention relates to a system and methods for communicating. More particularly, the present invention relates to a system including an apparatus and methods for facilitating communications to, by, and between persons with special needs.

### BACKGROUND OF THE INVENTION

For those with special needs—such as students having what is termed “print disabilities” (that is, disabilities that prevent them from normal reading of the printed page)—access to information that utilizes special notations and symbols such as mathematical and scientific formulae and equations is limited. Providing this information aurally is not a completely satisfactory solution to the problem. Ambiguities are created when technical notations are spoken. The term “technical notations” will also be used in this application to refer to that information that is or includes special notations and symbols such as mathematical and scientific formulae and equations. Students with print disabilities may have a hard time understanding the technical notations that typically occur in math and science textbooks by just listening to someone read the math to them. This is mainly because of the lack of a standard for spoken mathematics, and also the traditional problems associated with reliance on a human assistant. This is a problem that can affect the ability of students to learn from grade school through graduate school.

To better define the need, consider the following simple mathematical equation as it would likely be read by a human reader:

x equals a over B plus 1.

When a print-disabled student attempts to visualize this equation, there are actually two possible meanings (or visual renderings) for the equation, as shown below:

| Rendering A | Rendering B |
|---|---|
| $x = \frac{a}{B} + 1$ | $x = \frac{a}{B + 1}$ |

Which is the correct version? For a print-disabled student taking a test, the answer is crucial. Unfortunately, current techniques for the aural communication of mathematical subject matter are rife with these kinds of ambiguities, in addition to being of inconsistent quality, expensive, and time-consuming to produce. The current reality of everyday life as for print-disabled math and science students is that most materials are not available in alternative format and, hence, human assistants must be constantly employed. Such ambiguity creates a drain on both time and money for both the student and the school.

Several systems currently exist that are intended to provide some assistance to the persons with print disabilities that must work with technical notations. For example, Recordings For the Blind and Dyslexic (http://www.rfbd.org/) has used the Handbook for Spoken Mathematics (Chang, 1983) as a guideline for their recordings. This is a set of loose guidelines for reading mathematics by which human readers are trained to read and record math books on tape for blind users. This system is not designed for computer-automated generation of spoken mathematics. The input source is print only—not a scripting language.

A system for rendering machine-readable mathematical formulae using Linux, LaTEX, and Emacspeak is known (T. V. Raman's work at http://www.cs.cornell.edu/lnfo/People/raman/). However, this system is limited to non-XML input sources (i. e. LaTEX). It is also limited to a specific platform (Linux) running a specific program (Emacspeak).

The Design Science tool called the MathPlayer™ (see http://www.mathtype.com/en/products/mathplayer/) is an Internet Explorer-based plugin that renders MathML in a loosely formatted spoken language. However, this system is limited to a specific input source (i. e., MathML). It is also limited to a specific platform (Windows) running a specific program (Internet Explorer). Also, there is no real “specification” for, and therefore, no uniformity to the speech output; rather, the tool uses a series of loosely applied rules that are not internally consistent.

Dr. Abraham Nemeth set out some basic rules for Braille encoding of math and Science. An article discussing Dr. Nemeth's suggested lexicon can be found at (http://www.nfbcal.org/s e/list/0033.html).

Accordingly, a demand exists by which subject matters including technical notations can be communicated with few or no ambiguities to those with special needs. The present invention satisfied the demand.

### SUMMARY OF THE INVENTION

The present invention is directed to a system and includes apparatus and methods for creating a precise, consistent communication of technical notations. The present invention provides standardization for the aural communication of content by which equations, derivatives, integrals, fractions, and other algebraic, scientific, and mathematical components may be clearly communicated to a user. This system can be implemented through the use of software that is capable of accepting one or many different types of input and is capable of providing one or many different outputs that communicate technical notations wholly or largely wholly free of ambiguities, such output utilizing a number of methods and/or devices.

Additional features of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 illustrates a method for converting content, such as technical notations, into output, such as spoken language;

FIG. 2 is a more detailed flowchart for the method of FIG. 1;

FIG. 3 is a flowchart showing the overall principle of multi-input, multi-output processing;

FIG. 4 is a list of the illustrative input formats accepted by the system described;

FIG. 5 shows the translation of an acronym and the potential consequences of such translation;

FIG. 6 is a list of the illustrative output formats of the system described;

FIG. 7 shows the media conversion process;

FIG. 8 illustrates the disclosed media products and delivery channels;

FIG. 9 shows the process of converting a source document into an audio or other product;

FIG. 10 shows the steps involved when a rendering engine is used to create the output product as an electronic file;

FIG. 11 shows an example of coding required for a simple mathematical equation; and

FIG. 12 shows another example of coding required for the simple mathematical equation, this time using instructions for speech rendering.

### DETAILED DESCRIPTION OF EMBODIMENTS OF THE INVENTION

The present invention is directed to a system 100 including an apparatus and methods by which technical notations can be accurately described and communicated to one or more individuals with special needs. Specifically, the invention uses inputted data 10 and adds “reserved words” (underlined in the examples below) to eventually indicate to the user what the actual semantic meaning of the technical notation is intended to be. Thereafter, the modified data is outputted in a format desired by the user. Accordingly, technical notations can be interpreted (or visually rendered) largely in only an unambiguous way.

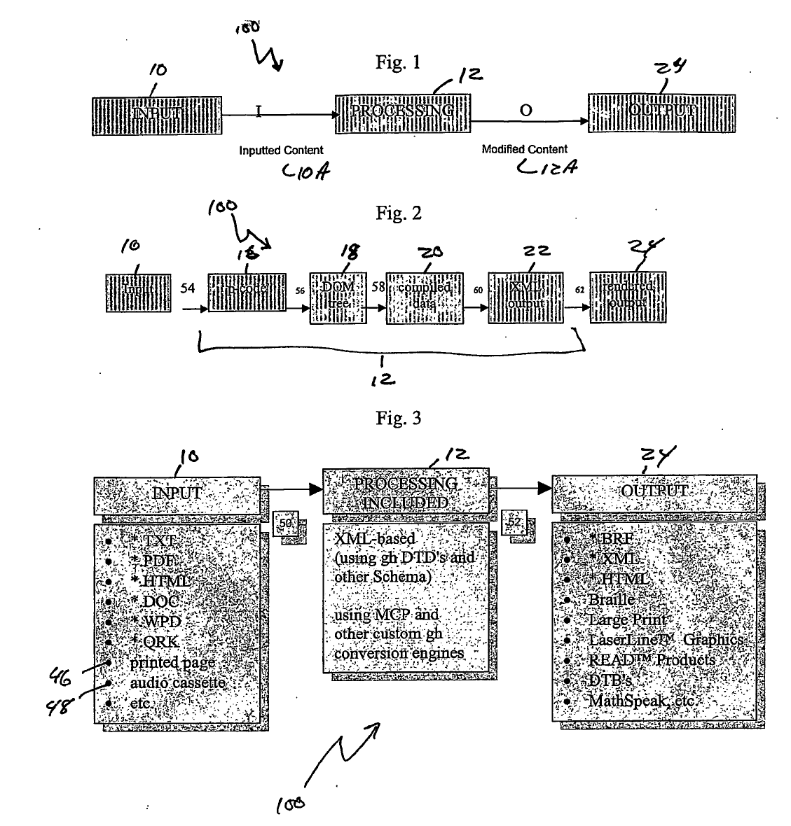

With reference to FIG. 1, system 100 encompasses any one or more inputs 10 that when subjected to a processing step 12, yield outputs 24. The processing step 12 incorporates several sub-steps, as illustrated in FIG. 2 and detailed further below.

Input 10

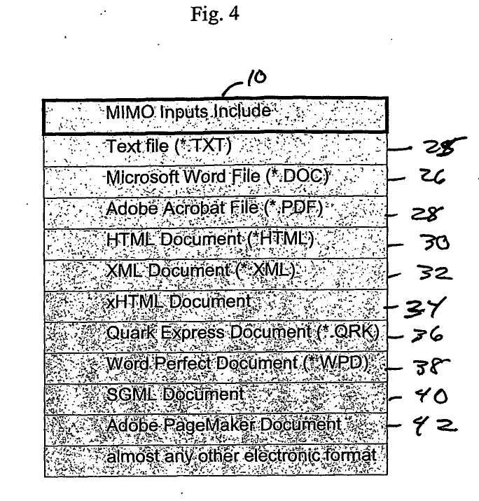

As can be seen in FIGS. 3 and 4, numerous input methods and devices are possible. The inputs 10 may include information already in digital format or information in other formats including a printed page or audio recording. This is commonly termed “Multi-Input Multi-Output”, or “MIMO”. Turning to FIG. 4, illustrative of the content that may be inputted in step 10 may include a text file 25, a Microsoft Word file 26, an Adobe Acrobat File 28, an HTML document 30, an XML document 32, an XHTML document 34, a Quark Express document 36, a Word Perfect document 38, an SGML document 40, an Adobe PageMaker document 42, or any other type of electronic document. Additionally, the input 10 may be a printed page 44 or an audio recording 46, as can be seen in FIG. 3. Among the other forms of inputs, are:
MathML 1.0
MathML 2.0 (presentational or semantic)
LaTEX
XML (containing math)
SGML (containing math)
Any non-math content/file format

Output 24

The processing 12 of the inputted content 10A can produce modified content 12A in various formats. When the output format is electronic, it could be reproduced in a variety of custom playback and viewing programs. It should be noted that almost any kind of electronic output format can be outputted or delivered. The output may be Nemeth Braille Code, an image delivered in any number of formats, an audio stream delivered in any number of formats, or a text stream delivered in any number of formats.

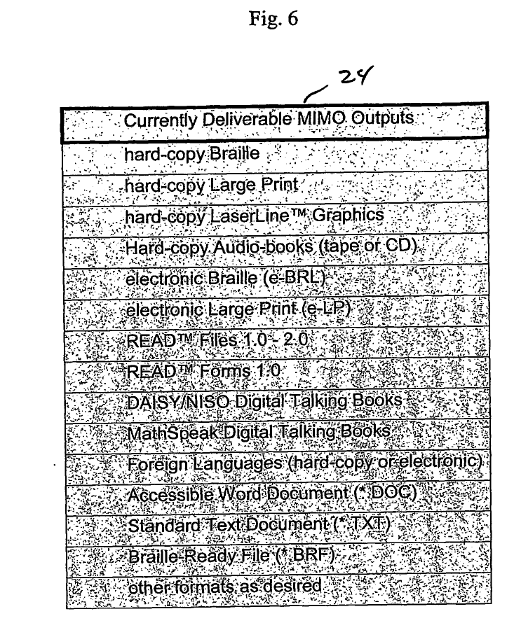

When the output format is a hard-copy, it can be pre-rendered and produced as an actual physical copy, by printing, embossing, mastering, and other large-scale production techniques. FIG. 6 lists some of the standard output formats currently delivered. However, it should be understood that other formats are within the scope of the invention.

It should also be noted that the use of XML allows the output files to be delivered in a variety of delivery channels. The output formats can be accessed as hard copy, using a computer (via the Internet or removable media such as CD-ROM), using a telephone (cellular or land-line), and using a television (via Interactive Cable Television).

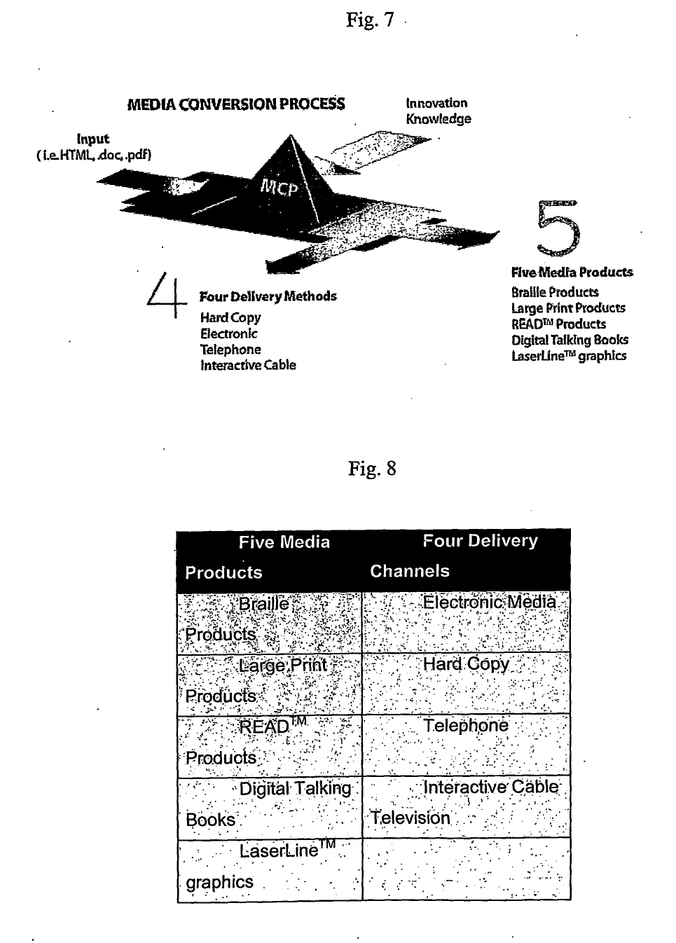

The Media Conversion Process (“MCP”) is a method by which the various outputs can be delivered to the end user. The product “5:4 accessible media solutions”, described further herein, illustratively offers persons with print disabilities (including students, employees, and consumers) five media products and four delivery methods for accessibility. However, it should be understood that this is only illustrative, and other combinations are within the scope of the invention. The “5:4 accessible media solutions” product enables persons with print disabilities equal access to information contained in documents. FIGS. 7 and 8 further illustrate these products and delivery channels.

5:4 accessible media solutions are an important element of the equal access because persons with print disabilities may work within an effective environment and possess sufficient technology, but the media may be inaccessible and in short supply.

Basic Overview of Processing 12

An automated process can automatically convert the input data into p-code 16, a proprietary XML-based standard. This process (labeled step “50” in FIG. 3) could be implemented with the use of a semi-automated toolset to visually format and markup the data prior to automated conversion to XML. The XML data content 10A is then passed through conversion engines in the processing-output step 12 and produced as a variety of outputs 24. It should be understood that while the proprietary XML-based standard disclosed above is used, the use of other XML-based standards or other codes are within the scope of the disclosure. The output creation process (labeled step “52” in FIG. 3) involves the production of the desired output from the XML data using a multitude of conversion tools. The processing-output step is nearly completely automated, and requires only the supervision of a translator. During each step of the process, and especially after the output is produced, the content can be reviewed, such as by a quality control specialist.

Once the input content 10 is converted into p-code 16 (or any other standardized code, as mentioned above), further processing may convert the inputted data into organized, hierarchical trees and additionally adds the reserved words to create an unambiguous interpretation of the mathematical or scientific passage. Such reserved words are discussed and exemplified in more detail below. During the processing, a source XML-based document is converted into a variety of output formats. In the case of the production of hard-copy materials, the rendering can be done on computers and then a resultant hard copy produced. In the case of the electronic products, various systems for the playing of the content are available (including by gh and found at www.ghbraille.com) that are able to render the information in real-time on the client's computer, telephone, or television, thereby allowing for maximum flexibility on the client's end.

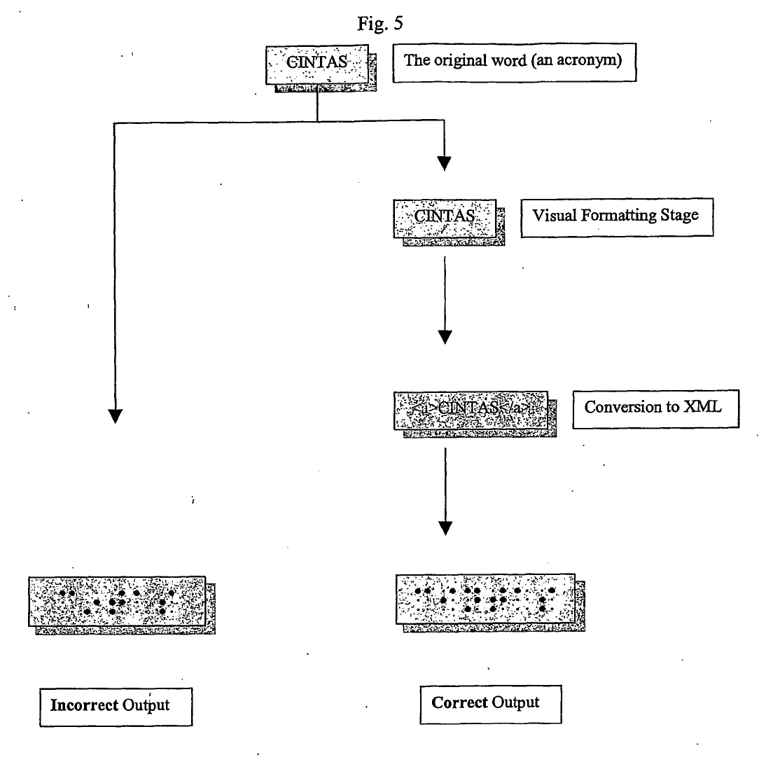

Additional ambiguities in Braille translations may be obviated through the proper use of XML element tags. FIG. 5 illustrates a specific example in the case of acronyms, which are commonly mistranslated in Braille. The left column represents when an acronym is translated without MIMO—no cues are available to the translation engine, so the acronym is translated incorrectly into Grade 2 Braille. The right column represents the translation with MIMO. The acronym tag tells the engine to translate correctly in Grade 1 Braille.

The XML documents that are used during the processing step are developed using document type definitions (“DTDs”) and other XML Schema. DTDs employ custom element tags, attributes, Cascading Style Sheets (“CSS”), and other technologies in order to fully mark up the data for translation, and render the data in a variety of output formats.

The processing step 12 incorporates the following sub-steps, as illustrated in FIG. 2.

Step 54: Convert Input to “p-code”: In this step 54, the input data 10 (which could be in a variety of formats—see FIG. 3) is converted into the above-referenced “p-code” 16 in preparation for further processing using a lexor (lexical parser).

Step 56: Convert “p-code” to DOM tree: In this step 56, DOM of the p-code is scanned and the hierarchical tree 18 is constructed and ordered (described in more detail below).

Step 58: Convert DOM tree to Compiled Data: In this step 58, each element of the tree is examined and converted according to the appropriate lexical rules, described further herein. The tree is then deconstructed back into a conventional data stream 20 using the additional rules of syntax, grammar, prosody, verbosity, and semantic interpretation described below. This data 20 is compiled and ready for the next step.

Step 60: Convert Compiled Data to XML output: In this step 60, the compiled data is formatted as a valid XML document 22 and additional transformations are applied (via XSLT and similar techniques) to prepare a document suitable for rendering. At this time some additional application of the rules may be necessary to encode certain information for the specific rendering agent (such as font colors for the visual rendering agent, and so forth). This rendering agent information may be specific to the individual agent and differ between agents (such as the difference between encoding font color for Internet Explorer versus Mozilla).

Step 62: Convert XML output to rendered output: In this step 62 the XML output 24 is rendered using a variety of agents. The visual rendering is done using a browser widget, and images are generated (in a variety of file formats) for each individual math element in the document. This may also include the application of complex visual style sheets to the output. Similarly, audio may be generated using a text-to-speech (TTS) engine designed specifically for the purpose, which produces an audio stream (in a variety of file formats) that contains the sound information to correspond with each math element. Likewise, a text stream (in multiple file formats, but illustratively XML) can be generated containing the exact text analog (the “words”) that are spoken in the audio file. Finally, a corresponding Braille stream (in a variety of file formats) may be generated for display either visually, on a refreshable Braille display, or as hard-copy print.

Turning to the exemplary fraction discussed above, the presently disclosed system 100 is configured to utilize this process to accurately interpret the phrase “x equals a over B plus 1” with both the proper contents of the fraction and with the fact that the denominator is a capital (as opposed to lowercase), as reprinted below:

$$y = {x}_{j}^{2 {e}^{- {i}_{n} π}}$$

Such an equation would be communicated to the listener in the following format:

x equals BEGIN FRACTION a OVER CAPITAL b END FRACTION plus 1.

(Reserved words are underlined.) The grammatical system that is used can also provide immediate feedback as to the current location of the listener in a complex equation. This means that a listener can actually follow along as a long string of math is read without getting “lost”. Consider the following equation:

$$x = \frac{a}{B} + 1. \qquad Rendering A$$

This would be spoken as follows:

y equals x SUBSCRIPT j SUPERSCRIPT 2e SUPER-SUPERSCRIPT minus i

SUPER-SUPER-SUBSCRIPT n SUPER-SUPERSCRIPT pi BASE.

Although this equation is complex regardless of the circumstances, this invention provides an accurate and unambiguous method of conveying the information at hand. During any part of the equation or technical notation, the user can deduce exactly what level of super- or sub-script that they are currently hearing/reading without having to wait for more context cues. Hence, the subscript of “n” for the variable “i” in the second-level superscript can be properly identified as SUPER-SUPER-SUBSCRIPT or “go up, up again, and then down”.

There are several components to this language (referred to herein by its trademark “MathSpeak”) by which technical notations may be communicated. These are:

Lexicon—The lexicon is the list of words created specifically for the MathSpeak language (these are known as “reserved words”). They are used to describe print mathematical entities and constructs which may not otherwise have words to describe them in ordinary English, or may not typically be voiced in ordinary English. For example, the beginning and ending of a fraction is typically not voiced when reading “½” in print, but it is voiced/imbedded when described in the presently disclosed apparatus and methods.

Syntax—The order of “reserved words” is carefully defined, e.g. “BEGIN FRACTION” versus “FRACTION BEGIN”. Providing this continuity ensures less confusion by the user.

Grammar rules—Reserved words have certain rules for modification, for example, “SUPER-SUBSCRIPT” versus “SUB-SUPERSCRIPT” and so forth.

Prosody and non-verbal cues—Much information can be imbedded and conveyed in an audio stream. For example, stereo, pitch change, and different voices can all be used to convey different content or context. The system may use a male voice for content and a female voice for reserved words, for example. However, many types of information could be communicated in a number of other ways.

Verbosity Controls—Different levels of verbosity (e.g. Maximum Verbosity, Verbose, Brief, and SuperBrief) are disclosed, each of which having a set of rules that lengthens or shortens the audio stream depending upon how much information the reader requires or desires. For example, “BEGIN FRACTION” is shortened to “B-FRAC” at the lower verbosity settings.

Semantic Interpretation Controls—In mathematics, the actual content is automatically interpreted with meaning by a sighted reader. For example, a reader might identify “x²” as “X SQUARED”. However, this can be accommodated in the presently disclosed apparatus and methods. This so-called “semantic interpretation” can range in complexity from the simple example given above to the more complex example of “f(x)” read as “F OF X” (meaning a function name). The reader adjusts this based on the desired level of cognitive load when using the disclosed apparatus and methods.

Definition of MathSpeak Lexicon

The initial groundwork for the MathSpeak lexicon is given below.

Letters

Lowercase letters are pronounced at face value without modification. They are never combined to form words. In particular, the trigonometric and other function abbreviations are spelled out rather than pronounced as words. For example, “s i n” is spelled out rather than said as “sine,” “t a n” rather than “tan” or “tangent,” “l o g” rather than “log,” etc.

A single uppercase letter is spoken as “upper” followed by the name of the letter. If a word is in uppercase, it is spoken as “upword” followed by the sequence of letters in the word, pronounced one letter at a time.

For Greek letters, the system can either provide that the word “Greek” is said first, followed by the English name of the letter, or in the alternative, the Greek name may be spoken. Thus, the reader might say “Greek e” or “epsilon.” Uppercase Greek letters can be pronounced as “Greek upper” followed by the English name of the letter, or “upper” followed by the name of the Greek letter.

Digits and Punctuation

In the illustrative example, digits are pronounced individually, rather than as words. Thus, 15 is pronounced “1 5” and not “fifteen”. Similarly, 100 is pronounced “1 0 0” and not “one hundred.” An embedded comma is pronounced “comma,” and a decimal point, whether leading, trailing, or embedded, is pronounced “point.”

The period, comma, and colon are pronounced at face value as “period,” “comma,” and “colon.” Other punctuation marks have longer names and are pronounced in abbreviated form. Thus, the semicolon is pronounced as “semi,” and the exclamation point is pronounced as “shriek”.

The grouping symbols are particularly verbose and therefore abbreviated forms of speech can be used. Thus, “L-pare” would be used for the left parenthesis, “R-pare” for the right parenthesis, “L-brack” for the left bracket, “R-brack” for the right bracket, “L-brace” for the left brace, “R-brace” for the right brace, “L-angle” for the left angle bracket, and “R-angle” for the right angle bracket.

Operators and Other Math Symbols

In the examples disclosed herein, a speaker would say “plus” for plus and “minus” for minus. “Dot” would be used for the multiplication dot and “cross” for the multiplication cross. “Star” would be used for the asterisk and “slash” for the slash.

“Superset” would be used in a set-theoretic context or “implies” in a logical context for a left-opening horseshoe. “Subset” would be used for a right-opening horseshoe. “Cup” (meaning union) would be used for an up-opening horseshoe and “cap” (meaning intersection) for a down-opening horseshoe. “Less” would be used for a right-opening wedge and “greater” for a left-opening wedge. “Join” would be used for an up-opening wedge and “meet” for a down-opening wedge. The words “cup,” “cap,” “join,” and “meet” would be standard mathematical vocabulary.

The terms “less-equal” and “not-less” are used when the right-opening wedge is modified to have these meanings. The terms “greater-equal” and “not-greater” are used under similar conditions for the left-opening wedge. The term “equals” is used for the equals sign and “not-equal” for a cancelled-out equals sign. The term “element” is used for the set notation graphic with this meaning, and “contains” is used for the reverse of this graphic. The term “partial” is used for the round d, and “del” is used for the inverted uppercase delta.

The term “dollar” is used for a slashed s, “cent” for a slashed c, and “pound” for a slashed I.

The term “integral” can be used for the integral sign, “infinity” for the infinity sign, and “empty-set” for the slashed 0 with that meaning. “Degree” can be used for 5 a small elevated circle, and “percent” for the percent sign. “Ampersand” would stand for the ampersand sign, and “underbar” for the underbar sign. “Crosshatch” would mean the sign that is referred to in other contexts as the number sign or pound sign.

The term “space” would indicate a clear space in print.

Fractions and Radicals

“B-frac” could be used as an abbreviation for “begin-fraction,” and “E-frac” as an abbreviation for “end-fraction”. “Over” would be used for the fraction line. Even the simplest fractions would use “B-frac” and “E-frac”. Thus, to pronounce the fraction “one-half” according to this protocol, the spoken word would be, in one embodiment, “B-frac 1 over 2 E-frac.” By this convention, a fraction is completely unambiguous. If the spoken word is “B-frac a plus b over c+d E-frac,” the extent of the numerator and of the denominator are completely unambiguous.

A simple fraction (which has no subsidiary fractions) is said to be of order 0.

By induction, a fraction of order n has at least one subsidiary fraction of order n−1. A fraction of order 1 is frequently referred to as a complex fraction, and one of order 2 as a hypercomplex fraction. Complex fractions are fairly common, hypercomplex fractions are rare, and fractions of higher order are practically non-existent. The order of a fraction is readily determined by a simple visual inspection, so that the sighted reader can form an immediate mental orientation to the nature of the notation with which he is dealing. It is important for a braille reader to have this same information at the same time that it is available to the sighted reader. Without this information, the braille reader may discover that he is dealing with a fraction whose order is higher than he expected, and may have to reformulate his thinking, sometimes long after he has become aware of the outer fraction.

To communicate the presence of a complex fraction, therefore, the terms “B-B-frac,” “O-over,” and “E-E-frac” can be used for the components of a complex fraction, somewhat in the manner of stuttering. For a hypercomplex fraction, the components are spoken as “B-B-B-frac,” “O-O-over,” and “E-E-E-frac,” respectively. The speech patterns are designed to facilitate transcription in the Nemeth Code, according to the rules of that Code.

Radicals

Radicals are treated much like fractions. The terms “B-rad” and “E-rad” can be used for the beginning and the end of a radical, respectively. Thus, “B-rad 2 E-rad” can be used for the square root of 2.

Nested radicals are treated just like nested fractions, except that there is no corresponding component for “over.” Thus, the use of the terms “B-B-rad a plus B-rad a plus b E-rad plus b E-E-rad,” alerts the braille reader to the structure of the notation just as the sighted reader is by mere inspection, and the expression is unambiguous.

Subscripts and Superscripts

A subscript may be introduced by saying “sub,” and a superscript by saying “sup” (pronounced like “soup”). Therefore, for “x square;” the spoken terms would be “x sup 2”. The term “base” is used to indicate the return to the base level. The formula for the Pythagorean Theorem would therefore be spoken as “z sup 2 base equals x sup 2 base plus y sup 2 base period”.

Whenever there is a change in level, the path, beginning at the base level and ending at the new level, is spoken. Thus, if e has a superscript of x, and x has a subscript of i+j, it would be termed “e sup x sup-sub i plus j.” And if e has a superscript of x, and x has a superscript of 2, it would be termed “ e sup x sup-sup 2.” If the superscript on e is x square plus y square, the terms used would be “e sup x sup-sup 2 sup plus y sup-sup 2.” If an element carries both a subscript and a superscript, the entire subscript would be spoken first and then all of the superscript. Thus, if e has a superscript of x, and x has a subscript of i+j and a superscript of p sub k, it would be phrased “e sup x sup-sub i plus j sup-sup p sup-sup-sub k”.

If a radical is other than the square root, the radical index would be identified as a superscript to the radical. Thus, the cube root of x+y is spoken as “b-rad sup 3 base x plus y E-rad”.

Underscript and Overscript

The term “underscript” is used for a first-level underscript, and “overscript” for a first level overscript. “Endscript” is used when all underscripts and overscripts terminate. Thus, an exemplary phrase would be “upper sigma underscript i equals 1 overscript n endscript a sub i”. “Un-underscript” and “O-overscript” would be used for a second-level underscript and a second-level overscript, respectively. All the underscripts are spoken in the order of descending level before any of the overscripts are spoken. Each level is preceded by “underscript” with the proper number of “un” prefixes attached. Similarly, the overscripts are used in the order of ascending level. Each level is preceded by “overscript” with the proper number of “O” prefixes attached.

This description of the lexicon is far from comprehensive. A complete, consistent, and extensible lexicon for the presently disclosed apparatus and methods has been developed which will allow the aural rendering of any mathematical topic. This lexicon is based on two sources: the MathML 2.0 Specification and the Nemeth Braille Code for Mathematics and Science. The goal of this is to develop a one-to-one function mapping the MathML content model over to a lexicon, as a precursor to an eventual XSLT process. A more thorough description of the presently disclosed language “in action” can be found at http://www.gh-mathspeak.com/examples.php, incorporated herein by reference.

The lexicon disclosed in the present invention is chosen to coincide with Nemeth Braille lexicon for several reasons. First, this allows an easy transition to and from Nemeth Braille for blind users. Second, since Nemeth Braille is extensible, this allows for the presently disclosed lexicon to be extensible as well (meaning that it can be expanded as needed by users to encompass new constructs not in the original lexicon). Finally, the grammatical rules for Nemeth Braille are set forth in such a way as to provide maximal aid to the reader, and hence the grammatical foundation for the presently disclosed lexicon will not be damaged by the selection of Nemeth as the lexical basis set.

Modifications of Lexicon Based on Computer Speech Issues

Although the lexicon itself must be developed purely from a standpoint of linguistic and pedagogical concerns, reducing the language of the presently disclosed lexicon into practice requires further modifications. Modifications to the lexical basis set have been researched based on the realities of computer-based speech rendering. Certain words or phrases are not fully suitable for computer audio rendering due to problems with enunciation or pronunciation, discriminability, and so forth. The changes made to account for this are subtle but important changes designed to maximize the effectiveness of the computerized apparatus and methods disclosed herein.

Linguistic Applications and Grammatical Rules

The presently disclosed apparatus and methods do not merely utilize a lexical basis set alone, but a true language, replete with rules for grammar and prosody. Research into the rules for building a computer-based language demonstrates that grammatical rules are of equal importance to lexicon when designing computer parsing algorithms for language.

The original intent of the lexicon designed by Dr. Nemeth was to create a so-called “zero-zero” grammar that would give readers complete contextual information at each word in the audio stream, without requiring them to wait for later modifiers. In the above example with multiple nested super- and sub-scripts, the listener can understand at each word in the stream what level of super- or sub-script is current. This allows a user to focus on the actual math content and not on memorizing complex level changes. Such an approach is also conducive to computer-based navigation, where the presence of a “cursor” allows a reader to control navigation through the technical notation. The end goal is a complete language ready for enablement using the presently disclosed apparatus and/or methods in a variety of Digital Talking Book products.

Conversion Engine

The presently disclosed conversion engine is the method by which the source computer-encoded math content is converted into a spoken language output. This is the processing step 12 referred to above. The method for doing this may be a compiler process, which is generally illustrated in FIG. 1.

As noted above, a plurality of inputs is converted into an internal “p-code” 16, which can then be converted into a plurality of outputs 24. This “p-code” is an internal code used specifically for the generalized “tokenization” of the source material into a format which can then be described and processed as a “tree” (e.g., for example, U.S. patent application Serial No. 10/278,763 entitled “Content Independent Document Navigation System and Method”). A “tree” is a hierarchical method for organizing the information in a general manner that allows the compiler to extract structural meaning from the content—as referenced in step 18. This extraction allows the actual content (such as the lexicon, syntax, grammar, etc.) to be converted in any manner desired without affecting the structure (the meaning) of the information. Hence, the subject and predicate of a sentence could be preserved even if the actual words that comprised them were converted into another language. Using a mathematical example, the numerator and denominator of a fraction can be preserved while the fraction itself is re-ordered (the syntax) and spoken in a different manner than print (the lexicon).

The disclosed processing step is similar to the Media Conversion Process (described below) for the generation of textbooks containing math information. The main difference is that the disclosed engine is a real-time tool for the rendering agents to use in displaying content from source material, and the MCP is an off-line tool for the production of source material (math-containing books).

Rendering Agents

There are several rendering agents that have been developed for the presently disclosed apparatus and methods, and which are components of various computer applications such as the gh PLAYER, gh TOOLBAR, and Accessible Testing Station that gh offers (such products can be obtained through gh at www.ghbraille.com). Examples of rendering agents are a Braille rendering agent, a visual rendering agent, an audio rendering agent, and a text rendering agent. Each is described below.

Braille Rendering Agent

The Braille Rendering Agent is responsible for generating a Braille output stream (in a variety of file formats) for display either visually, on a refreshable Braille display, or as hard-copy print, from an input of the XML output.

The Braille rendering agent is a separate compiler program that applies the linguistic rules of Nemeth Braille (in a manner very similar to the Mathspeak Engine itself) to produce proper context and properly formatted Braille output.

Visual Rendering Agent

The Visual Rendering Agent is responsible for generating a visual output for display in a browser, from an input of the XML output.

The visual rendering is done using a browser widget, and images are generated (in a variety of file formats) for each individual math element in the document. This also includes the application of complex visual style sheets to the output.

The visual rendering agent is a separate compiler program that generates valid CSS and XHTML from the XML output for display in browsers such as Internet Explorer and Mozilla.

Audio Rendering Agent

The Audio Rendering Agent is responsible for generating an Audio output stream (in a variety of file formats) for display through speakers or headphones, from an input of the XML output.

The audio is generated using a Text-To-Speech engine designed specifically for the purpose, which produces an audio stream (in a variety of file formats) that contains the sound information to correspond with each math element.

The audio rendering agent is a separate program that contains a TTS parser and engine that parses the XML output, breaks the information down into a string of phonemes, selects a sound sample to associate with each phoneme based on contextual information, and then concatenates those samples into an overall sound file for the complete audio stream.

Text Rendering Agent

The Text Rendering Agent is responsible for generating a text output stream (in a variety of file formats) for display in a browser, from an input of the XML output.

A text stream (in multiple file formats, but mainly XML) is generated containing the exact text analog (the “words”) that are spoken in the audio file.

The text rendering is done using a browser widget, which also includes the application of complex visual style sheets to the output. The text rendering agent is a separate compiler program that generates valid CSS and xHTML from the XML output for display in browsers such as Internet Explorer and Mozilla.

XML, or extensible Markup Language, is a universal method for data storage and exchange that can be used in the MCP. XSLT, or extensible Stylesheet Transformation Language, is a method by which one “flavor” of XML can be converted to another. In general, the process of converting a source document into an audio product, as disclosed herein, occurs in three main steps, as shown in FIG. 9.

The input step 110 involves the re-authoring of the source material into MathML (and other scripting languages) format. This input 110 is then converted using Process I into an XML format. Steps I and O collectively form the processing step 112.

The second process O converts XML into a more specific “flavor” of XML, such as VoiceXML, which is useful to produce the output. This is typically accomplished by use of XSLT. Next, a rendering engine is used to automatically create the output product 124 as an electronic file, from which physical hard copies can be mastered. A summary of this process is shown in FIG. 10.

Step Oₓ involves an XSLT to convert the XML 116 into VoiceXML 118, which can be used to automatically generate computer-synthesized speech. Step O_{y} involves the actual generation of this computer-synthesized speech as an electronic master audio file 120. Finally, step O_{z} produces the physical copies of the book or test on Audio CD's (or CD-ROM's) 122 for use by the individual customers.

More detail about each of the three steps for integration of the presently disclosed apparatus and methods into MCP is given below:

XML Schema Development

An XML Schema is a special file that defines the features, including elements and their attributes, of the core XML specification. For example, the commonly-used DTD (Document Type Definition) is an example of a kind of Schema for XML. A Schema can be developed for the presently disclosed apparatus and methods that encompasses all of the needed features of the apparatus and methods as a specific subset of both the general XML and MathML, which is the coding language of choice for mathematics. This Schema can be developed using the Microsoft 4.0 Software Development Kit and can conform to the proposed W3C XML 2.0 specification.

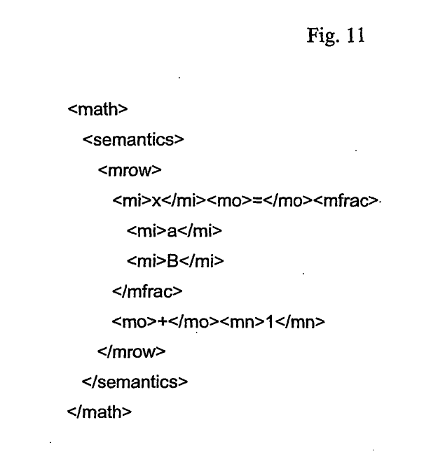

One element of the step is to develop a correlation between each fundamental mathematical entity in MathML and each spoken representation. An example of the MathML coding involved for even a simple equation such as the fraction first illustrated above is shown in FIG. 11.

XSLT from XML to Voice XML

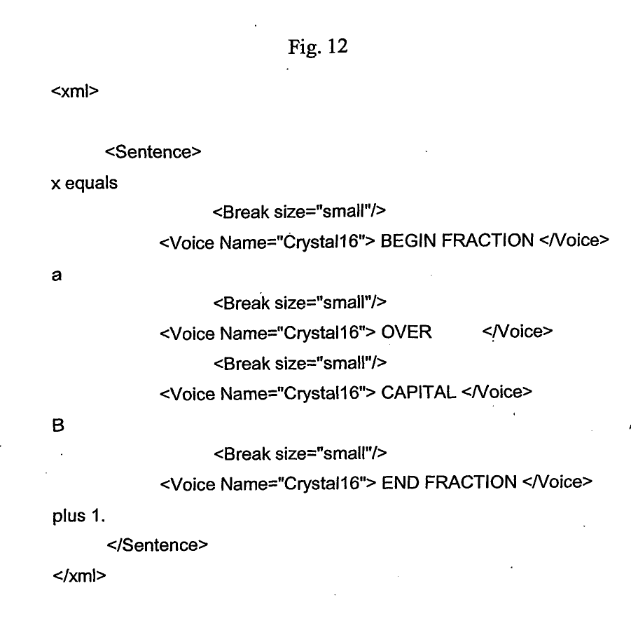

During this step XSLT will be used to convert the XML file into the actual VoiceXML file needed for generation of audio. VoiceXML is an XML standard that is used primarily for speech recognition purposes by large phone companies; however, it can also be used for the production of speech output as opposed to speech input. The XSLT can replace each construct with an instruction to the speech rendering engine of what, and how, to speak the element. An example of the output of this process, again taken from the first simple fraction example, is shown in FIG. 12.

Note that the original elements such as the MathML <mfrac>. . . </mfrac>element, which is used as a container for a fraction, has been converted to the reserved words BEGIN FRACTION . . . END FRACTION instead by the XSLT. Note also that these reserved words are surrounded by VoiceXML commands to pause slightly and change the voice from male to female, in order to improve clarity for the listener. Of course, many other audio enhancements can be done with VoiceXML as well.

Automated Generation of Audio

After the VoiceXML file has been generated, the actual master audio file can be created. This is done with the assistance of a Text-to-Speech (TTS) engine. A TTS engine converts the VoiceXML document into a sequence of phonemes, or basic units of sound, along with special commands as to how those phonemes should be synthesized. While off-the-shelf TTS software is typically used for audio generation, a specialized TTS engine would need to be developed for the correct pronunciation, diction, clarity, and audio effects needed for proper rendering of the math content.

There are several major parts to any TTS engine:
1. High-quality, digitally recorded samples of human speech, broken down into phonemes (the smallest units of sound for human speech), which is used as the model for the computer-generated voice.
2. A dictionary of English words and their phonemic equivalents.
3. A program that concatenates the phoneme samples into actual words and phrases by using the dictionary.
4. A program that alters the sample phonemes with special audio effects, including pitch and rate changes, volume changes, and pauses or blank space.
5. A program that interprets non-verbal parts of text such as punctuation, prosody, and parsing of general VoiceXML commands and converts that into special instructions for the program above.

Rendering the Product

The resultant output of the MCP will be a product composed of an electronic file and an audio track. This will be rendered both visually an aurally by the addition of a rendering module to an existing product, such as the gh PLAYER™ for Digital Talking Books. Other gh products can render the information as well, such as the gh TOOLBAR, the Accessible Testing System, and the Accessible Instant Messenger (again, information on gh products is available at www.ghbraille.com).

The presently disclosed apparatus and methods may also be utilized to convert speech into Braille or printed math into Braille. Such a system could allow, for example, a blind student to create a copy of his homework. Such a system may also be modified so that it can be utilized to create printed technical notations. Such a system may have utility outside of the field of disabilities, for example, in the transcription industry.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A method of communicating a technical notation a user, the method comprising the steps of:
converting the notation into data,
inputting the data into a processor to produce inputted data for processing,
said processing including using a lexicon to convert the inputted data into outputted data, and p1 outputting the outputted data into a format decipherable by the user.

2. The method of claim 1, wherein at least one code selected from a code group comprising LaTEX, XML, and SGML is used during said converting step.

3. The method of claim 1, wherein the notation is from a digital file selected from a format group comprising a text file, a Microsoft Word file, an Adobe Acrobat file, an HTML document, an XML document, an xHTML document, a Quark Express document, a Word Perfect document, an SGML document, and an Adobe PageMaker document that is converted through use of said converting step.

4. The method of claim 1, wherein the notation is a printed page that is converted through use of said converting step.

5. The method of claim 1, wherein the notation is an audio source that is converted through use of said converting step.

6. The method of claim 1, wherein said using a lexicon step includes drawing from Nemeth Braille Code parameters.

7. The method of claim 1, wherein said outputting step includes configuring the outputted data into a format decipherable by the user having print disabilities.

8. The method of claim 1, wherein said outputting step includes generating a Braille output stream.

9. The method of claim 8, wherein the Braille output stream produced through the use of said outputting step is in an output group comprising a display, a web site, a Braille display, and a Braille-printed page.

10. The method of claim 1, wherein said outputting step generates a visual output stream for display as an image.

11. The method of claim 10, wherein the visual output stream is directed to at least one from an output stream group comprising a web browser, a document, and a display screen.

12. The method of claim 1, wherein an audio output stream is generated through use of said outputting step.

13. The method of claim 12, wherein said outputting step utilizes a text-to-speech converter.

14. The method of claim 1 wherein said outputting step generates a text output stream.
